(19) United States
(12) Patent Application Publication
(10) Pub. No.: US 2010/0010872 A1
(43) Pub. Date: Jan. 14, 2010

(54) PERSONA-BASED CUSTOMER RELATIONSHIP MANAGEMENT TOOLS AND METHODS FOR SALES SUPPORT

(76) Inventors: Glen Drummond, Kitchener (CA); Richard Hill, Elora (CA)

Correspondence Address: MILLER THOMPSON, LLP, Scotia Plaza, 40 King Street West, Suite 5800, TORONTO, ON, M5H 3S1, CA

(21) Appl. No.: 12/498,772

(22) Filed: Jul. 7, 2009

Related U.S. Application Data
(60) Provisional application No. 61/078,489, filed on Jul. 7, 2008.

(51) Int. Cl. G06Q 10/00; G06Q 50/00

(52) U.S. Cl. 705/10; 705/7

(57) ABSTRACT

The present invention represents a web-based, CRM-integrated system and method for unlocking the creativity of salespeople at all levels when selling to different buyer personas within a buying community throughout the buying cycle. The system of the present invention may be flexible and may integrate the collection of data through questions posed to a user, as well as secondary data sources. This data may be utilized to create a tool for the sales process and to facilitate learning by salespeople. The tools created and utilized by the system may include personas, playbooks, and matrixes. These tools may be designed to facilitate the identification of a best action or choice in response to a particular situation or dilemma.

This application claims the benefit of U.S. Provisional Patent Application Ser. No. 61/078,489 filed Jul. 7, 2008.

### FIELD OF INVENTION

This invention relates in general to the field of web-based sales-force automation and customer relationship management tools and more particularly to a persona-based system to support sales.

### BACKGROUND OF THE INVENTION

Alan Cooper is broadly credited with championing the use of personas as a practical interaction design tool in 1998. In the context of interaction design, personas are “a precise descriptive model of the user, what he wishes to accomplish, and why.” (Cooper, About Face 2.0) Interaction designers use personas to solve specific design questions, such as: “What should appear when Bill (the user persona) first visits our website?”

Since 1998, applications of personas by industry have spread to influence other practices, such as product design, marketing and sales. Personas help professionals in a variety of roles answer questions like; “What product should we be building” (product managers), “What message should we be communicating” (marketers), and “What types of conversations should I be having with different prospects” (salespeople). A typical persona description includes a photo, name, title role, and narrative descriptions of: (1) attributes that help the reader identify with the persona; (2) daily responsibilities with relation to the strategic context of the product or service on offer; and, most importantly; (3) burning needs—pain points, obstacles or problems that currently exist that interfere with success for this persona; and (4) goals that speak to the underlying motivations behind typical customers' attitudes and behaviors.

A distinction can and should be drawn between personas with profiles. Profiles consist of information intended to support rational understanding and action. Personas are stories intended to bring user information to life in the imagination of a reader to support intuitive or “abductive” thought and action. Personas help the salesperson recognize and identify with the prospect as a human subject rather than an object in a sales-person's narrative. And while profiles are primarily developed by analyzing and reducing market research data to a finite system of variables, personas are typically developed by synthesizing observations from one-to-one interaction with the targeted population (commonly gathered through ethnographic field research involving a combination of in-depth, in-person interviewing along with direct observation, preferably in the actual usage context.) The distinction, in summary, between profiles and personas is one of function. Profiles transmit a finite set of codified information about people. Personas provoke imaginative and empathetic responses to people. Both of these functions are relevant in sales effectiveness tools, but neither function as substitutes for the other, and this leads to the conclusion by experts in the field that profiles and personas are not functional substitutes for each other.

“Buyer personas” for salespeople representing target decision makers and influencers help salespeople get deeply inside the heads of would-be customers to better understand and empathize with their goals, concerns, preferences and views of the world. And when salespeople understand buyers so intimately, they can better anticipate the articulated and unarticulated needs of different people and tailor conversations accordingly. Buyer personas are also helpful in equipping reps to have more consultative, solution-selling conversations, where the focus is on what customers want to achieve versus what products the rep has to sell. Above all, buyer personas help salespeople get past their personal opinions and presuppositions to understand what users truly need.

Personas are represented as a feature in existing sales applications. For example, ShadeTree™ applies personas in its ShadeTree MATRIX™ product to aid its selling team in performing their tasks. In this context personas include written descriptions of each person in the buying community crafted to be applicable to certain solutions, products or services. Specific components of ShadeTree™ personas include a user's context, goals, pain points, and major questions that may require answers. Additionally details such as individual objectives, compensation plans and reporting structures may be included. The personas are applied to help marketing and selling teams better understand their target audience. This application of personas emphasizes information over narrative, reflecting, perhaps, a conflation of assumptions about the function served by profiles and personas in a salesforce automation (SFA) solution.

Other features of sales tools are applied in the present market. For example, Advizia™ utilizes an advisor component focused on pointing to particular product solutions in its tool Advizia Product Advisor™. This advisor feature guides users to particular products. Product advice is based upon an evaluation of a customer's needs by way of easy-to-understand questions. The answers to these questions and are used to guide the customer to products that meet their requirements.

Sales coaching tool, such as a conversation playbook are applied as components of Landslide™ and inciteKnowledge™ software packages. Landslide utilizes a playbook to integrate marketing content into the selling process, and inciteKnowledge™ uses a playbook to provide sales teams with selling content, tools, and practices to help them in their sales. In particular inciteKnowledge™ uses playbooks that deliver coaching, strategies, presentations, documents and other tools salespeople need to engage with buyers.

Questions and recommendations are also used in isolation or combination as tools to enhance resources and to produce library tools for a sales product by some companies. The SAVO Group™ uses questions so that a recommendation may be created to reflect known information and the messaging needs relating to a particular customer. The Sant Corporation™ utilizes questions to create customer-focused presentations, whereby slides in a presentation, such as a Powerpoint™ presentation, may be chosen based upon information supplied by a customer using the system so as to provide information appropriate to the specific customer.

### SUMMARY OF THE INVENTION

In one aspect, the present disclosure relates to a system for customer relationship management through personas comprising: a persona data collection tool; a prospect data collection tool; a rules processor; and one or more logic models; wherein the rules processor and the one or more logic models utilize persona data generated by the persona data collection tool, and prospect data generated by the prospect data collection tool for the purpose of identifying a situation match.

In another aspect, the present disclosure relates to one or more tangible computer-readable media having encoded thereon computer-executable instructions for causing a computer programmed thereby to perform a method comprising: comparing data related to a prospect selected by a user to scenario matrixes stored in logic models by way of a rules processor; and identifying one or more personas deemed to be relevant to generate a situation match based upon the comparison and the identified one or more personas.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a diagram of the Customer Coach system of the present invention.

FIG. 2 is a sample buyer persona display.

FIG. 3 is an interactive playbook display.

FIG. 4 is a resource builder display.

FIG. 5 is a flowchart of the user logic of the Customer Coach system of the present invention.

FIG. 6 is a diagram of the system architecture of the Customer Coach system of the present invention.

FIG. 7 is a two-dimensional model matrix embedded in buyer persona community calculation.

FIG. 8 is a three-dimensional model matrix embedded in buyer persona community calculation.

FIG. 9 is an example solution model matrix.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention relates a web-based, customer relationship management (CRM) integrated system, computer product, tool and method for unlocking the creativity of salespeople at all levels when selling to different buyer personas within a buying community throughout the duration of a buying cycle. Personas may be one of the tools invoked by the system of the present invention. Specifically, the present invention system may support the creation and application of personas to aid in the process of product sales and/or sales person training. The system, tool and method of the present invention may facilitate a format that unleashes the creativity of salespersons in order drive more effective and targeted selling conversations with different types of buyers throughout the buying process.

One embodiment of the present invention may be commonly referenced as the “Customer Coach” system. The present invention may offer a proactive sales support system and tool accessible to users via web-browsers and the Internet, and, more particularly, integrated within web-based CRM systems, wherein buyer personas (and tailored information, advice and resources) may be presented to salespeople.

The buyer personas of the present invention may encompass fictional characters, that may be realized with a name, a face, and a rich biographical profile that illustrates goals, patterns, attitudes and perceptions recognized through in-depth qualitative research. Such buyer personas may be applied in a variety of ways. For example, buyer personas may be used to profile different target buyers and their likely role throughout the buying cycle. Buyer personas may also be created to support a buying community.

The system of the present invention may apply a method of selecting and displaying the right buyer persona (from a set of possible buyer personas within a buying community) and assigning it to individual leads within a CRM system. This can allow for subsequent content, messaging, sales advice and resources provided by the system of the present invention to be tailored in the context of persona (in combination with other situation specific inputs as supplied by the user).

This may empower salespeople to better prepare, anticipate and have, more targeted, relevant and customer-centric conversations with buyers than existing sales support systems currently allow for. This method of integration of personas within a CRM system is a benefit over the prior art that dose not apply such a method.

The present invention may function so as to require a salesperson user to enter data about a prospect, including information regarding the stage of a buying cycle that the prospect is engaged in. A rules processor may then compare the data to scenario matrixes stored in logic models to generate a “situation match”. Depending on the data entered, the situation match may determine one or more of the following: the most likely persona for allocation; the most appropriate solutions to meet the prospects needs; and the most effective resources for both the user and the prospect at that point in time. The situation match may further be the basis for providing the most relevant advice, resources and content for salespeople based upon the data. Content selected and pushed back to the user may be termed “Intelligent Advice”. The salesperson may leverage the Intelligent Advice to provide a basis for higher quality and more relevant conversations with prospects which in turn may keep the ensure the forward momentum of a sales opportunity.

It is generally recognized that the creation and application of personas within a sales system can be a key element of a successful selling tool. Existing prior art products present personas that are essentially buyer profiles. The present invention may provide a system that goes beyond a mere buyer profile to paint in the minds of salespeople a rich, narrative and personal picture of different buyers, what makes them tick, and their role in a potentially bigger “buying community”. The present invention may further apply personas to create a situation survey component.

Thus, the present invention may be a sales effectiveness solution that centers on heuristics (including buyer personas) intended to unleash the full intelligence and creativity of the sales representative. The technical system of the present invention may offer prompts and suggestions, but avoid prescription.

Existing prior art applications that involve personas commonly apply information intended to support rational understanding and action. The present invention may apply character-centered stories to stimulate the imagination of the salespersons and allow them to guide the buying process with greater empathy and creativity. While such a system may improve selling performance, the improvement may not be attributable to artificial intelligence substituted for human skill. Instead the improvement of known systems may be attributable to an enhanced structuring of the sales representative's creative problem-solving process.

The present invention may facilitate a clarification of the respective roles of man and machine in its design. The present invention may address important problems identified in the existing CRM and SFA applications and may produce a tool that: (a) is more likely to be adopted by sales professionals; (b) may offer value to sales representatives across a wider range of skill levels; and (c) therefore may allow for more effective and systematic deployments.

In one embodiment of the present invention, personas can be integrated with CRM applications, which may include methodologies, software, and usually Internet capabilities that help an enterprise manage customer relationships in an organized way. For example, an enterprise might build a database about its customers that described relationships in sufficient detail so that management, salespeople, people providing service, and perhaps the customer directly could access information, match customer needs with product plans and offerings, remind customers of service requirements, know what other products a customer had purchased, and so forth.

The present invention offers several benefits over prior art CRM tools. For example, prior art CRM tools focus on storing and providing access to left-brain intensive data—the details around the who, what and when of sales transactions (who did we call, what is their address, when did we talk to them). Such prior art falls short in terms of more valuable right-brain insight into how to consummate business. Prior art sales support applications do not currently leverage personas to their full potential to unleash the creativity of salespeople and help them better connect to their customers within a CRM environment. The present invention offers a tool, system and method that achieves right-brain insight and also leverages personas to unleash the creativity of salespeople to help them connect to their customers.

The existing field of digital sales effectiveness tools is subject to several drawbacks, including that sales people often do not like to use them; the best sales people are less likely to use them than rookies; solutions designed for the most successful sales professionals are ill-suited to the most junior, and vice versa; and from a sales management standpoint, it becomes hard to implement and gain consistent adoption (and thus effective deployment) of these tools. The present invention overcomes these drawbacks and therefore offers a benefit over the prior art.

Another benefit the present invention offers over the prior art is the use of personas in conjunction with widely-available technology Marketing Automation and Sales Force Automation platforms can optimize the potential for improved time-effectiveness of sales professionals. In particular, the success rate of sales professionals in converting leads to sales may be improved. This may occur because the present invention facilitates the connection of market segmentation process, lead nurturing and consultative selling.

Yet another benefit that the present invention may offer is derived from marketing segmentation research to create a typology of buyer motivations and the use of this typology as input. Automated observation of audience response to communications stimuli, for example such as web page views following links provided by email, can be used to profile leads according to the typology. The outcome is that typology may be used to make communications progressively more relevant through a lead nurturing lifecycle.

A further benefit of the present invention is that it may be guided by a consultative and experience-based approach to building and programming business rules into a marketing automation platform, instead of by a single, secret algorithm. For example, once the probability of a match between an individual sales lead and one of the “personas” reaches an acceptable threshold of confidence, the system can then pass the contact to the salesforce automation software platform. The contact may be elaborated with the metadata of “persona”.

Another benefit of the present invention is that the metadata of “persona” may shape how a sales representative is guided. Such guidance may include prompting regarding questions to ask, information to share, sequence of events, tone and style of communication, as well as objections to anticipate. The guidance may facilitate efficiency of the performance of these tasks by developing a probability-based automation of sales-representative decision support.

The present invention may apply key observations about sales professionals and software developers. For example, sales professionals can be creative people that have the characteristics of intuition and creativity. As another example, software system builders may build logical systems. So, when software system builders build systems for sales professionals, they may build systems that reflect a bias towards logical thinking that is essential to successful software development. This path-dependency produces expert-systems that reflect, in various levels of fidelity, the image of artificial intelligence. Thus, most prior art sales systems are created to be driven by logic, which addresses only one aspect of successful selling. Creativity, imagination, intuition and empathy are not logical, but can be critical to successful selling. The challenge then is to develop a software-enabled system that helps a salesperson access both the logical and the intuitive aspects of their abilities in order to improve their performance in helping customers buy. This is one goal of the present invention.

Although born out of technology called “sales force automation”, traditional CRM tools are regarded by many salespeople as offering few benefits to them. The term “automation” may be an important clue here. The present invention may facilitate sales as an inherently creative process, as well as an analytical one. The impulse to hard-code rules for sales representative action based on a system of profiles is the natural tendency of software system developers, as shown in the prior art—but one that underestimates the scope of the sales process. The general sentiment in sales organizations is that most prior art CRM sales applications focus on managing salespeople—that is, they are of benefit mainly to sales management in helping create forecasts, build pipeline models, segment territories, etc. (Sullivan and Frost), but they offer few direct benefits for salespeople. In fact, most known prior art attempts at integrating personas within CRM application result in interaction designs where a profile prescribes action, rather than stimulates creativity around action.

The present invention has several significant features. It may be able to proactively push salespeople the right stimuli, advice and resources they need, at the right time in the buying cycle. Such stimuli, advice and resources may be tailored to meet the needs of a particular prospect.

The present invention also may generate product/solution recommendations for salespeople, based on pre-determined configurations by mapping all possible situational variables to all possible product/solution matches. Additionally, the present invention may facilitate tracking of when and which resources salespeople send to buyers, as well as tracking of, and creating alerts when, buyers download resources.

The present invention also may allow for salespeople to provide feedback on individual resources via rating scores and a comments thread.

Another aspect of the present invention is that it may have a dynamic and bi-directional nature in terms of data integration with CRM systems. The present invention may facilitate the extraction of the necessary data elements already existing in a CRM system (like name, industry, address etc) to populate relevant fields within the invention system. The present invention may further facilitate the exportation and population of data elements from the invention system back into the CRM system for storage.

As a skilled reader will recognize, the present invention is capable of a variety of configurations, organizations, implementations and embodiments. Several of these embodiments will be presented herein, however these should not be read so as to limit the scope of the invention.

### System Overview

Personas used by the system of the present invention may best be developed based primarily on data gathered as a result of first-hand observation and interviews with target buyers. This approach, known as ethnographic research, may be conducted in the environment in which target buyers will use or make purchase decisions about the product or service in question. This can provide an opportunity to observe not only what users say, but more importantly, what they do (as people's self-reported behavior is often inaccurate). Such as, for example typically 4-6 people in each buyer segment may be visited, with interviews ranging from 1-2 hours in duration. As a further example, a small-scale client project may visit 15 people across 3 segments and a large-scale client project could visit 64 people across 16 segments.

Additional data inputs may include interviews with client subject matter experts (SME's) and client stakeholders who interact frequently with buyers (i.e. salespeople or customer service personnel), and existing market research on the target market. A skilled reader will recognize that data may be provided from other sources as well.

Once any observational field research has been completed, all interview notes may be reviewed. Furthermore, discrete observations can be listed, and variables representing important attitudinal and behavioral dimensions identified (i.e. quality-oriented vs. price-oriented). Respondents may then be mapped against the identified set of key dimensions, with the aim being to identify groups of people who follow similar patterns across multiple dimensions. This insight may form the basis of a meaningful persona. Brief titles can then be given to these major groups (or clusters) of people, and full narrative descriptions may be built out. Insights may be drawn based upon insights gathered from the field around key behavioral traits and details, such as responsibilities, working environment, frustrations, relationships with others, skill level, risk, definition of success, demographics etc. While, “A list of bullet points might contain the same essential facts, but since personas do double duty as communication tools, a narrative is far more powerful in conveying the persona's attitudes, needs, and problems. The Cliff's Notes edition may convey the basic ideas, but it will never be as compelling as the story” (Cooper), each group of people may also be given a name and a photo to finalize the persona.

Connections between personas, and their relative roles in a buying community by stage in the buying process may also be identified, examined and noted.

Once at least one portfolio of personas have been identified and crafted, the content associated with each persona (i.e full narrative descriptions and photos) may be stored in the content database of the system of the present invention for access as required. A skilled reader will recognize that a variety of means of identifying and crafting portfolios of personas may be applied.

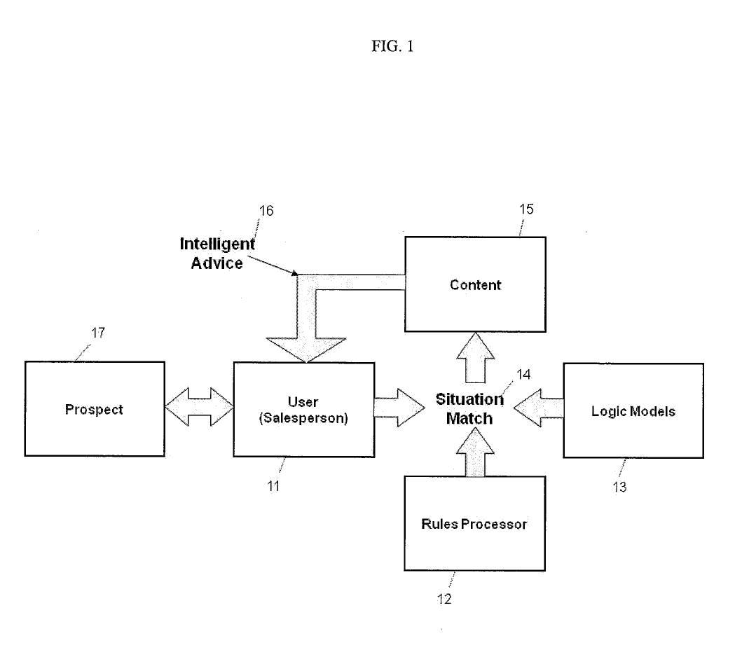

As shown in FIG. 1, one embodiment of the present invention may be a system involving several interactive elements. The system of the present invention may function so as to require a user 11, most likely to be a salesperson, to enter data about a prospect 17. The system of the present invention may include a rules processor 12 capable of comparing data entered by the user 11 about a prospect 17 to scenario matrixes stored in logic models 13 to generate a “situation match” 14. The situation match may determine, based on the information provided by the user: the most likely persona for allocation; the most appropriate solutions to meet the prospects needs; and the most effective resources for both the user and the prospect at that point in time. The situation match 14 may then be used to locate the most relevant advice, resources and content 15 for salespeople, the exact nature of which will vary based each clients unique instance. Content selected and pushed back to the user is referred to in the context of the present invention as “Intelligent Advice” 16. The salesperson can then leverage the intelligent advice to keep the sale opportunity moving forward by having higher quality, more relevant conversations with prospects 17.

The following identifies aspects and features of the present invention, but should not be read as limiting the scope of the invention. As skilled reader will recognize that the present invention may be configured to include multiple combinations of aspects, features, tools, elements, functionalities, etc.

### System Functionality

In embodiments of the present invention, the system of the present invention may be comprised of several functions and modules. Each may be accessed through a variety of means, including clicking, or touching a tab linked to the module displayed by the system of the present invention on a computer or other electronic or digital screen. A person skilled in the art will recognize that other means of selecting a module may be implemented in the system of the present invention. A description of each module follows:

### Buyer Persona Module

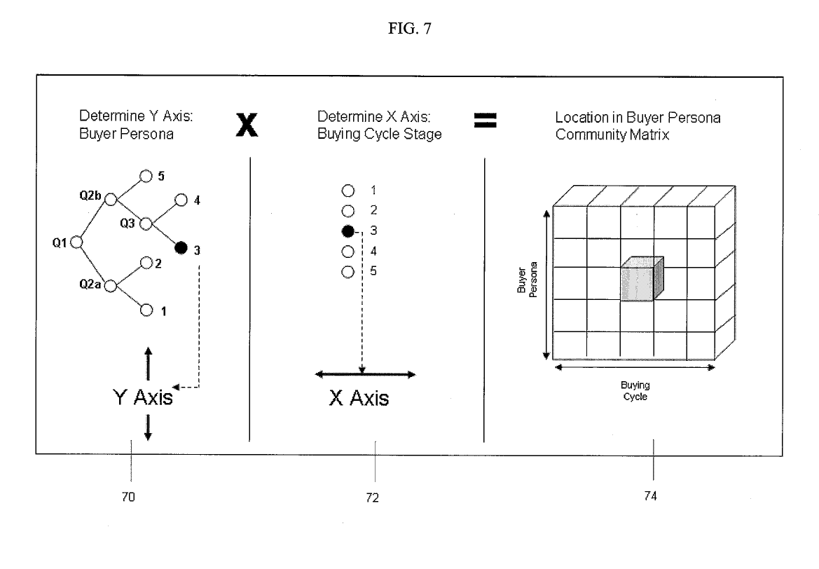

The buyer persona module may be utilized so as to allow users to view and select a buyer persona that best reflects their prospective lead. Users can self-select what they consider to be the most appropriate persona, or may use other means of accessing a persona, such as a wizard function, or a series of questions posed to users whereby the system of the present invention may determine the most appropriate matching persona (and likely buying persona community if relevant) according to logic, which may be expressed as rules or other logic means, contained within the buyer persona community model matrix, as shown at FIG. 7.

Multiple buyer personas may be identified by the matrix as relevant. Each of these personas can be considered in the course of the determination as to which is the most relevant. The persona identified as most relevant to a situation may change on a stage-by-stage basis during the selling process. However, the same personas may be identified as relevant in multiple stages. The level of relevance of each persona may alter from one stage to another. Another viewpoint of this type of stage specific identification of personas can be an identification of the ways in which the relationships between personas change in different stages. The relationships between personas is achieved particularly in an embodiment of the present invention that situates personas within a larger buying community.

In one embodiment of the present invention, the relationship between personas may be captured and displayed in a visual format to a user. As one example, a radar map may be utilized whereby personas identified as existing within a buying community that are deemed relevant to a particular stage of the buying process may be shown as having a particular proximity to a center location upon a radar. The persona closest to the center of the radar may be the one that is identified as most relevant. The present invention may consider the most relevant persona to be the one which is the best match and will therefore have the most influence upon a buyer. A radar map for each stage of the buying process may be generated, and the positions of the personas may alter from one radar map to the next, in accordance with the difference relevance of personas at particular stages of the buying process. While the relevance of a particular persona may be ascertainable upon such a visual depiction by its relation to the center of the radar, the relationships between the relevance of individual personas may also be ascertainable upon the map through the relative position of personas to each other. A skilled reader will recognize that a radar map is only one example of a form of visual depiction whereby the relevance of personas may be easily viewed and detected by a user, and therefore the present invention is not limited to a display of this information by way of a radar map, but may include a variety of depiction means.

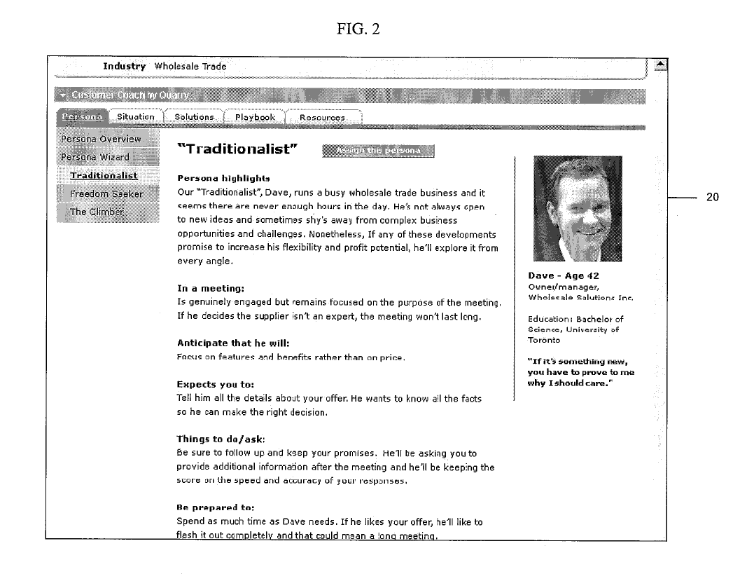

Once the present invention system has made a determination as to the best match, insight and information about the recommended buyer persona may be shared with the user. As shown in FIG. 2, in one embodiment of the present invention, a visual representation 20 of the persona identified as the best match may be provided. In one embodiment of the present invention, the sharing of a persona may occur within a story-telling format consistent with a true persona, not merely a profile. A skilled reader will recognize that FIG. 2 merely presents one example of a visual representation of a buyer persona and that a story-telling format is only on example of a means of communicating information related to a persona. Thus, the present invention is not limited to this format and representation, as many other representations and presentation formats may be applied in the present invention.

Moreover, in one embodiment of the present invention, the presentation of personas in a visual manner and the provision of information relating to the persona in a particular format, may be developed in a way so as to ensure that a whole-brain selling approach is achieved. For example, these elements of the present invention should be developed and applied so as to unleash the right-side, the creative side, of the brain. The outcome of this approach may be that salespeople are more empathetic and customer-centric in their selling approach because they have a better understanding of different buyers' views of the world and what is important to them. It may also provide representatives with an ability to better anticipate needs of the different customers they are likely to encounter.

The System may also be configured so as to display connections to other likely buyer personas in the buying community. In one embodiment of the present invention, this display may be presented by stage in the buying process.

### Situation Survey Module

The Situation Survey Module may involve the user answering a series of easy-to-answer questions about the buying and selling situation. Exact questions can be customized for each client instance. Customization may be achieved through consultation with clients to identify unique and key dependencies (i.e. conditions that must be present for situation matches to occur). Based upon data collected during the consultations, questions may be crafted to ascertain the presence, or lack thereof, of certain dependencies.

The answers provided to the crafted questions may be utilized as data input. The system of the present invention can utilize this data to select and populate the most relevant intelligent advice in subsequent modules.

### Solution Generator Module

The solution generator module may identify and display the best matching solution or set of solutions to meet the requirements of a prospect (according to the Solution Logic Model), based on data shared by the user in the situation survey.

### Conversation Playbook Module

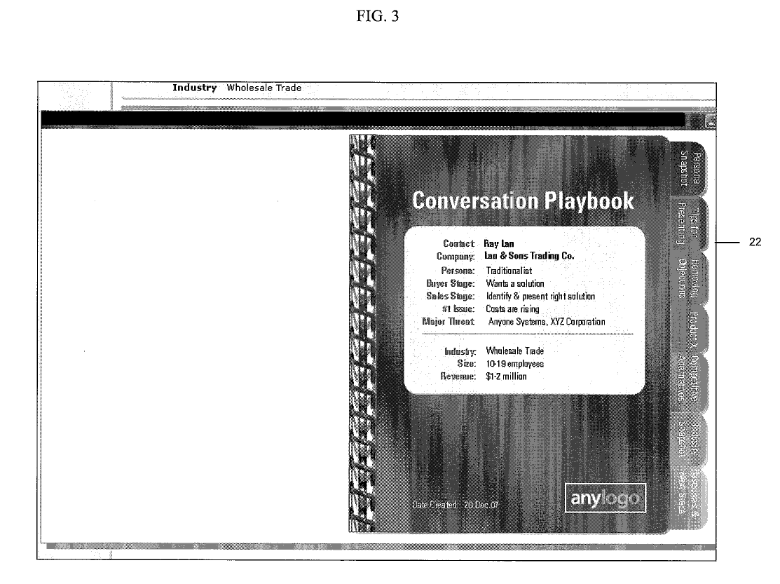

The Conversation Playbook module may be used to generate an interactive, customized playbook. In one embodiment of the present invention, as shown in FIG. 3, the playbook may include insights, advice and best-practices in relation to selling. The playbook contents may thereby enable salespeople to engage in more targeted and effective conversations with buyers. Said contents may be represented in a visual manner to a user by a variety of formats and representations.

In one embodiment of the present invention, a playbook display 22 may be dynamically created as an interactive portable document format (PDF). This may be achieved through the integration of PDF generation software, such as PDFLib, with the present invention. The playbook may additionally display content appropriate to user and prospect's unique situation, as determined by the conversation playbook model matrix. Each section of the playbook can be dedicated to a specific topic. Exact topics and content will need to be customized for each client instance. However, a typical playbook might include content referencing: buyer personas; advice ordered by the stages in a selling cycle; advice regarding how to overcome common objections; detailed information on any recommended product/solution; advice regarding how to reposition the competition; and intelligence on prospects organized by industry segment. Content for the playbook may be stored in the Content & Assets Database 50. The database may further be accessible by the PDF generation software. As outlined, content for the playbook may need to be custom developed for each client instance either by the system developer or by the client themselves.

### Resources Builder Module

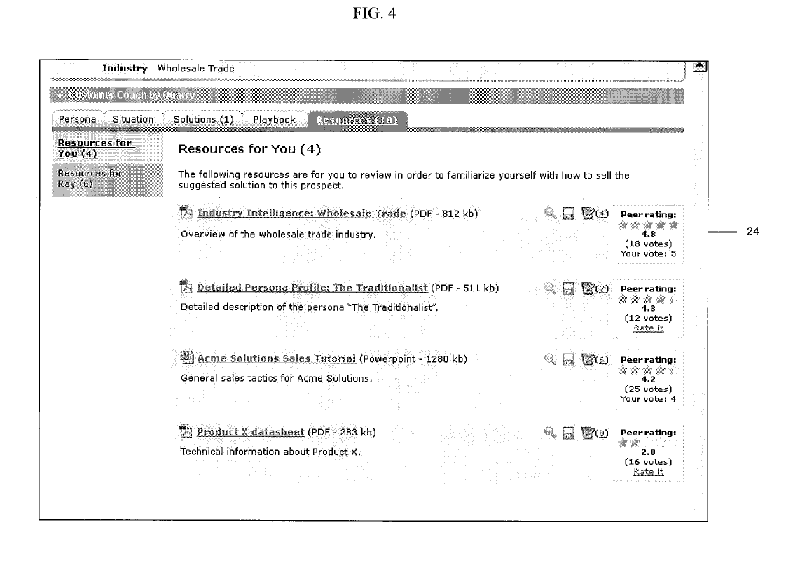

The resources builder module may be utilized to pinpoint and recommend the most appropriate collateral and resources available for salespeople and for customers. As shown in FIG. 4, this module may function in accordance with the Resources Logic Model Matrix.

In one embodiment of the present invention, the resources module may contain both static assets and dynamically created assets. Such assets may be tailored by buyer persona and other variables based on the input provided in the situation survey module. Thus, the content within certain assets may be chosen based upon information supplied by a customer using the system of the present invention, so that the information provided is appropriate to the specific customer.

Similar to the playbook, as shown in FIG. 4, existing PDF generation software, such as PDFLib, may be used to dynamically create such assets on-the-fly and create a playbook display 24. The software applied should be capable of dropping appropriate content into graphic templates to produce relevant output. The user may additionally have the ability to further personalize certain assets in some embodiments. Users might also personalize some assets by clicking a personalize icon. This may cause a series of screens to become available that will offer a function that will walk users through the process of further editing any content fields that the system administrators have deemed editable. For example, through this function it may be possible to change the text of a particular bullet point in a presentation slide deck. Moreover, it may be possible to add contact details to a brochure, or to change or select a new photo. A skilled reader will understand that these examples do not limit the scope of this function of the invention and that the function may incorporate different capabilities in accordance with various embodiments of the present invention.

In some embodiments of the present invention a peer review rating and comments thread functionality may provide real-time feedback regarding the utility of individual resources to salespeople, marketing and management. Through this element of the invention, the user may be granted the ability to group selected resources and collateral materials to create a package. This package may be emailed to a prospect. In one embodiment of the present invention, the email sent to the prospect may include links to a personalized URL, which further contains links that facilitate the downloading of items in the package. Thus, when prospects receive the email, they may be able to click upon an icon that will cause them to access their personalized URL. In this environment they may have the option to download, save and/or open each item accessible therein. A person skilled in the art will recognize that items in a package may be unique to each client's deployment of the system of the present invention. For example a package may include a presentation deck, a solution overview brochure and a video case study of client testimonials relevant to the industry of the prospect recipient. Each item in the package may be chosen to provide value-added content that may serve to accelerate buyers in their decision-making process by providing them what they need, when they need it. A skilled reader will recognize that the examples of packages provided herein by no means limit the potential scope of the possible content of packages of the present invention.

In one embodiment of the present invention, its system may have the ability to track emails and thereby be aware when prospects have download individual items in their package. Furthermore, this feature may allow the system of the present invention to and notify salespeople accordingly when particular items are downloaded. Notification may be facilitated by way of email alerts or other means. Alternatively, or additionally, the system may record the event in the CRM database.

In one embodiment of the present invention, the present invention may be integrated with other systems to extend the usefulness and impact of certain resources generated in the Resource Builder module. For example, this integration may expand the facilitation of presentations, as well as other resources of the system of the present invention. In one embodiment of the present invention, an integration with Brainshark™ may be achieved. Brainshark™ is system directed at composing, delivering, viewing and managing presentations over a communications network. Through the Brainshark™ application, a composer of a presentation may upload visual portions of the presentation to a host server. This transfer may be achieved over a communications channel such as the Internet or an Intranet. Once the presentation is uploaded for display through the host server, audio portions of the presentation may be recorded via a telephone link. The audio and video portions of the presentation may be linked and made available for viewing and listening simultaneously over a communications network. Through integration with the present invention personas and other tools of the present invention may be utilized to create a tailored presentation. This presentation may then be linked to an audio recording element and be presented simultaneously therewith to a user. In another embodiment of the present invention, the resulting presentation having visual and audio elements may be delivered via email.

In yet another embodiment of the present invention, marketing automation platform tools may also be integrated with the present invention. For example, Eloqua™ may be integrated with the present invention. Integration with Eloqua™ or another marketing automation platform tool may create a tool whereby the ability to track users who view particular marketing campaigns may be facilitated.

A skilled reader will recognize that Brainshark™ and Eloqua™ are only two examples of third-party tools that may be integrated with the present invention and that other third-party tools may also be integrated with the present invention to create enhanced functionabilities.

### Technical Architecture

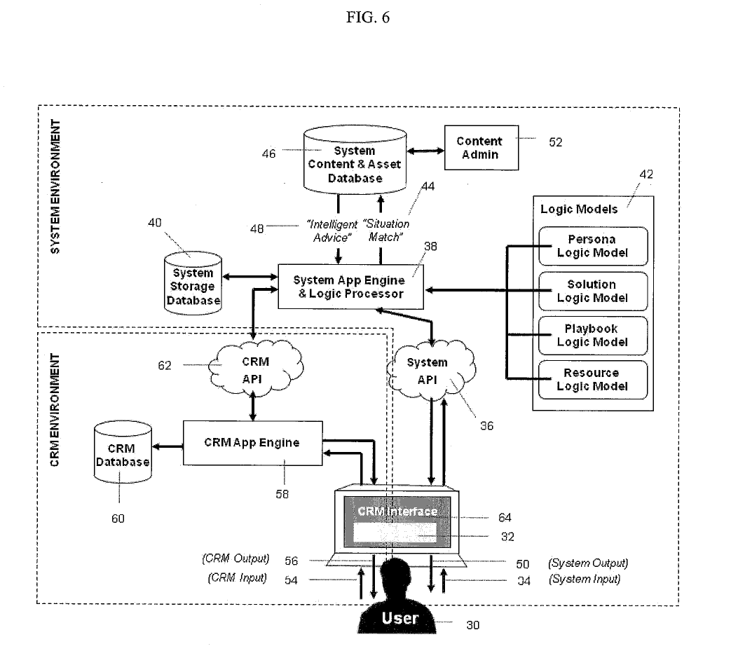

In one embodiment of the present invention, a technical architecture such as that shown in FIG. 6 may be applied. A user 30 may typically be a salesperson who routinely uses CRM systems to manage relationships with prospects and customers. CRM usage may involve input 54 into, and output 56 from the system of the present invention. Forms of input and output of the system may be consistent with those described previously. The CRM application engine 58 may be configured so as to be responsible for managing the CRM database 60, CRM API (application programming interface) 62 and CRM interface 64.

The System may be integrated within the client's CRM system interface 64. Moreover, the CRM system interface may be accessible through dedicated System user space 32. System content can be delivered into this System user space 32, which may ensure ease-of-use for salespeople by relieving them of the need to open a separate application to access this tool. Moreover, the delivery of system content into the user space may have the further benefit that a user may not be required to leave the workspace they are used to operating within to access the tool.

In one embodiment of the present invention, once its system is accessed, a salesperson may first be required to provide input 34 into the system. Such input may be created through the activity of answering a series of questions about the prospect that the user is targeting and any unique situation of the user. In other embodiments of the present invention, input may also be obtained from the CRM Database 60 using CRM API calls 62 to extract existing prospect information relevant to the system logic. This embodiment may allow for pre-population of answers to questions already known, saving salespeople time and effort.

In an embodiment of the present invention, input questions may be uniquely customized for each client instance, though questions will commonly relate to ascertaining any or all of the following information:
The prospect's likely persona (determined through the representatives answering questions which are mapped to findings from primary research that can accurately allocate a prospect to a persona based on the combination of a predefined set of responses);
The prospect's stage in the buying cycle;
The prospect's key issues and opportunities faced;
The sales reps stage in the sales cycle;
Any competitive threats;
A typical profile, including firmographic information, about the prospect's company (i.e. industry, number of employees etc).

In one embodiment of the present invention, inputs 34 may be provided by users. Specifically, the input data may be passed to the system application engine 38 via the system API 36. This information may then be stored in the system storage database 40 for future access by the system or by users of the system.

In another embodiment of the present invention, outputs may be requested by the user. To generate outputs the system application engine 38 may call on the system storage database 40 to compare the actual data entered by the user about a prospect and their situation to scenario matrixes that are stored in the logic models 42. The logic models may provide the system application engine 38 with the data definitions it requires to determine the most accurate situation match 44. Situation match 44 is the outcome of a function of the system of the present invention whereby it may determine of the most likely persona for allocation, and the most appropriate solutions to meet the prospect's needs. This information is used to reach a conclusion and identify the most effective resources for both the user and the prospect at that point in time. All of the steps in establishing a situation match may be based on the information provided by the user.

Once a situation match has been identified at by the system application engine 38, the system may be programmed to seek and return the most relevant intelligent advice 48 from the system content & asset database 46. Intelligent advice 48 may consist of tailored content and resources to prepare salespeople to have conduct more targeted and relevant conversations with buyers, based on their unique situation. Specifically, intelligent advice 48 may include, but would not be limited to:
Detailed information about a selected persona, including: that persona's view of the world; what is important to that persona; what that persona typically has at stake when making a purchase; as well as what that persona may expect from salespeople;
Guidance as to other key personas that may be of interest to salespeople in the buying community at the identified stage of the buying cycle;
Common buyer objections unique to the particular persona at the identified stage of the buying cycle;
Suggestions regarding how to re-position likely competitive threats and how to overcome them;
Industry intelligence outlining: an overview of the industry a prospect is in; how the industry operates; terms and phrases commonly used in the industry; as well as key industry issues and opportunities; and
Deeper, detailed information about the solution set recommended by the system of the present invention, including how to position value for that particular persona at the identified stage in the buying cycle.

In one embodiment of the present invention, the most relevant intelligent advice content and assets selected for the situation at hand may be compiled, generated and/or formatted for output using the system application engine 38. Outputs may be passed through the system API 36 back to the user 30 and subsequently made available for display in the user space 32 within the CRM system interface 64.

In another embodiment of the present invention a content administrator 52 interface may allow administrators to update content (i.e. update persona, add/delete Resources, etc.) of the system of the present invention as necessary.

### Logic Models

In embodiments of the present invention, the system of the present invention may be comprised of logic models. Each may function in a unique method. A person skilled in the art will recognize that the combination of logic models may differ between embodiments of the present invention. A description of each logic model follows:

### Buyer Persona Community Logic Model Matrix

The buyer persona logic model matrix uses a combination of at least two pieces of information to locate a situation match 74, 82. The information pieces may be used to identify the likely state of the Buying Persona Community from the range of all possible combinations.

In one embodiment of the present invention, each possible location on the matrix may have information associated thereto relating to intelligent advice. Such information is specifically relevant to the needs of each persona combination at each stage of the buying cycle. In one embodiment of the present invention, as shown in FIG. 7., for relatively simple buying persona community scenarios, the matrix may be made up of a combination of the following: the selected buyer persona and it's location on the Y axis 70; and the selected Buying Cycle Stage and it's location on the X axis 72. A skilled reader will recognize that other two-dimensional matrixes may also be created and applied by the system of the present invention.

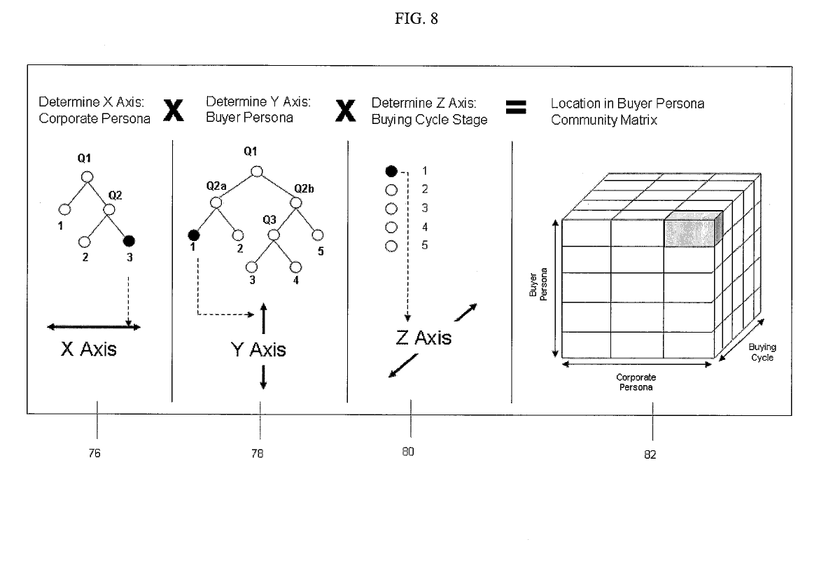

In another embodiment of the present invention, as shown in FIG. 8, other matrix configurations are possible for more complex buying community scenarios, such as a three-dimensional matrix. To address a situation where the Corporate Persona is an influencing factor (for example, when only certain buyer personas appear in certain Corporate Persona situations) the matrix may be made up of three pieces of information. First, the selected Corporate Persona and it's location on the x axis 76. Second, the selected buyer persona and it's location on the Y axis 78. Third, the Stage in the Buying Cycle and it's location on the Z axis 80. A skilled reader will recognize that other three-dimensional matrixes may also be created and applied by the system of the present invention.

In yet another embodiment of the present invention, both the selection of buyer persona and corporate persona may be first determined through users answering a series of questions about the buyer and corporation being targeted. Questions may be posed and answered in the persona profile module. The system of the present invention may access predetermined decision-trees to facilitate this function. The decision-trees may be developed based on insight gathered in field research around distinguishing behavioural and attitudinal dimensions of different personas. Decision-trees may further be used to map questions and answers to identify the highest likely persona.

In another embodiment of the present invention, both the selection of buyer persona and Corporate Persona may be determined from data captured and passed from Marketing Automation Platforms, such as Eloqua™. This data may be based upon a buyer's self-reported answers to a series of questions about themselves. Furthermore, the data may be gathered as part of a lead-nurturing marketing program.

### Solution Logic Model Matrix

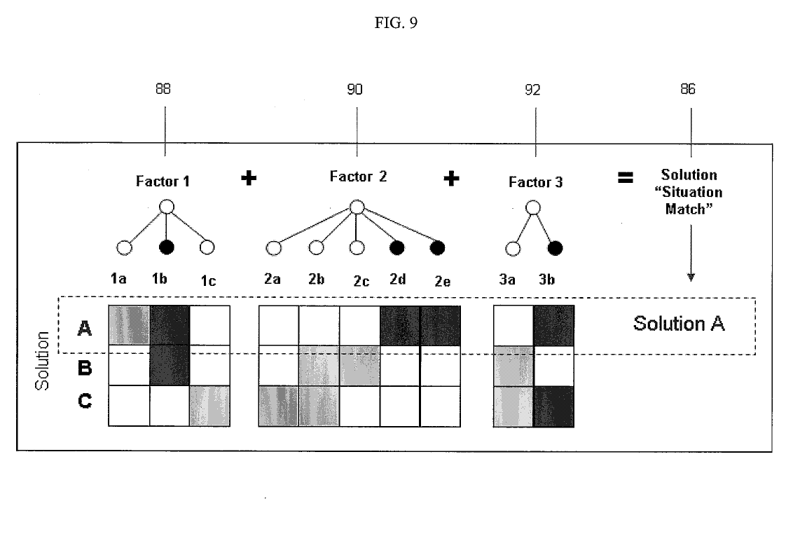

In one embodiment of the present invention a solution logic model matrix, as shown in FIG. 9, may be applied. Such a matrix may utilize a combination of two or more pieces of information to identify a solution situation match 86. In this context the solution match may be the best likely solution to meet the requirements and needs of the customer.

To identify the solution match, each possible solution may be assessed. A solution may also be scored against its ability to satisfy certain factors, requirements or dependencies. This can create the underlying map of solutions that satisfy certain factors, known as the map of solutions-to-factors-satisfied.

In one embodiment of the present invention, unique responses may be given to each of the factors. These responses may then be compared to the underlying map of solutions-to-factors-satisfied to determine the best solutions match. In this embodiment the solution that may be characterized as the best solution is on that satisfies the greatest number of factors and/or requirements. For example, as shown in FIG. 9, the sample solution logic model matrix may be utilized to identify the best solution in the following manner: Solution A, a solution situation match 86, may be evaluated as the best matching solution when the response to factor 1 88 is (b), there is multiple response of (d) and (e) to factor 2 90, plus a response of (b) to factor 3 92. A skilled reader will recognize that this example does not limit the scope of the invention, but is provided merely to exemplify a potential embodiment of the present invention.

### Conversation Playbook Logic Model Matrix

In another embodiment of the present invention, the conversation playbook logic model matrix may be applied. This matrix may utilize a combination of at least two pieces of information to locate “Situation Matches”. Situation matches may be those that identify the most appropriate and relevant content for a custom playbook. The content may be chosen from the range of all possible combinations in accordance with the persona and stage in the buying cycle.

In this embodiment, each possible location on the matrix may have information associated therewith that relates to intelligent advice. Thus, the information may reflect that which is specifically relevant to the needs of each persona combination at each stage of the buying cycle. For example, the following logic may be applied: for a buyer persona at a particular buying cycle stage, sections of content deemed the most appropriate to the persona and buying cycle stage will be presented to a user. As shown in FIG. 3, the presentation may be in the form of a dynamically generated playbook having a feature that allows a user to read through the particular pages of the book. For example, one or more tabs 22 may be presented which allow a user to click upon a particular tab and consequently be taken to the pages corresponding to that particular tab. A skilled reader will recognize that this example does not limit the scope of the invention, but is provided merely to exemplify a potential embodiment of the present invention.

### Resources Logic Model Matrix

In one embodiment of the present invention, the resources logic model matrix may be applied. This matrix may utilize a combination of at least two pieces of information to locate situation matches. A Situation Match may be the best resources available from the range of all possible resources given the persona and stage in the buying cycle. For example, the following logic may be applied: for a buyer persona at a specific buying cycle stage the most appropriate resources will be identified. A skilled reader will recognize that this example does not limit the scope of the invention, but is provided merely to exemplify a potential embodiment of the present invention.

In this embodiment, resources may be mapped to the most appropriate and relevant locations within the matrix. These locations may be chosen in relation to the potential value and effectiveness they offer to buyers and salespeople. The potential value of the location may specifically be assessed in relation to the needs of each persona combination at each stage of the buying cycle.

Moreover, in an embodiment of the present invention, mapping of resources to specific locations within the matrix may be conducted based on insight gathered from primary research. Such research may be designed to establish the value and effectiveness various resources offer to buyers. Furthermore, research may be based on the opinions and assessment of key client stakeholders.

### Example of Use of System

Embodiments of the present invention may be designed lend themselves to a variety of uses, within the context of providing aid to the progression of sales, and learning by salespersons. The following offer specific examples of uses that may be made of the system of the present invention. A skilled reader will recognize that these identified uses do not limit that scope of the invention in any way.

### Example Questions Posed to Users

In one embodiment of the present invention, users may typically be sales representatives. Moreover, the users may be asked to respond to the following four questions:
What type of persona might my prospect be, and what is likely important to them?
What conversations should I be having with my prospect at this stage in their buying cycle?
What solution set is right for my prospect, given their needs?
What materials and resources are most relevant for me, and my prospect, right now?

The responses to these questions may be stored by the system of the present invention. Additionally the responses may be utilized by the system in assessments and evaluations it undertakes, as described above.

A skilled reader will recognize that other questions may be posed by the system of the present invention and from these questions other data and results may be generated.

### Example Step Progression

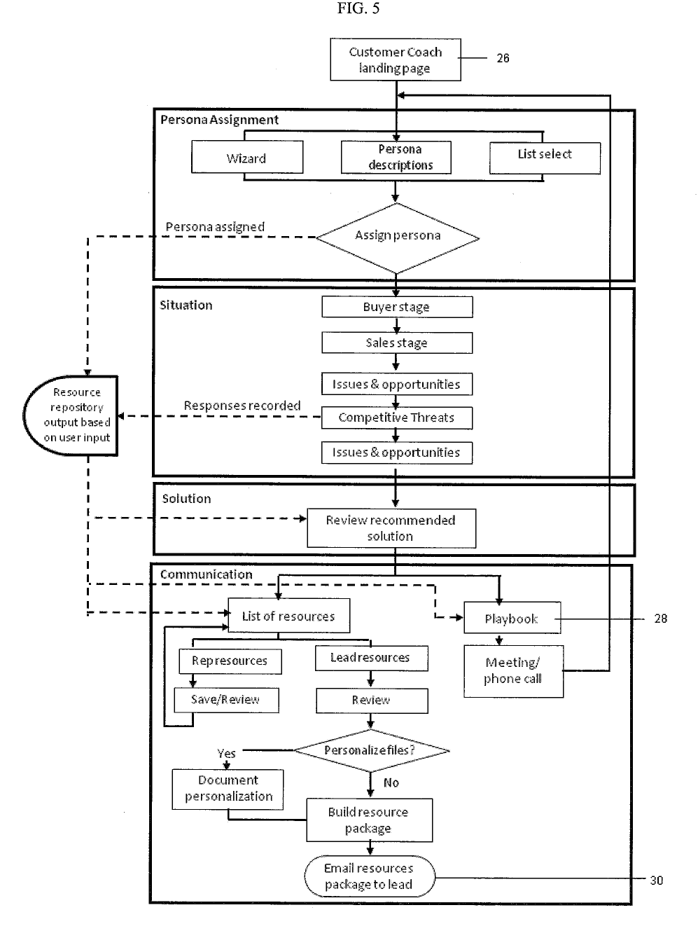

As shown in FIG. 5, in one embodiment of the present invention, a user session may follow the following general steps:
1. Login to CRM system and view Customer Coach landing page 26,
2. Select targeted prospect from leads list in CRM system,
3. Open system of the present invention,
4. Identify possible buyer persona match from list or through answering persona wizard questions,
5. Review buyer persona overview,
6. Assign buyer persona to lead,
7. Answer questions in situation survey,
8. Review recommended solution(s) in solution generator,
9. Open and review customized conversation playbook 28,
10. Save and/or print Conversation Playbook if desired,
11. Review and/or preview recommended resources and collateral materials for user (salesperson) and lead in Resource Builder,
12. Further personalize selected collateral if desired,
13. Add selected resources and/or collateral materials to package of materials to be emailed to prospect,
14. Email package to prospect 30, containing links to a personalized URL where each item is available for prospects to download.

As a person skilled in the art will recognize the user flow described herein is merely an example of a possible user flow. Other presentations and user flows are possible to accommodate the needs of various users and buying communities.

It will be appreciated by those skilled in the art that other variations of the embodiments described herein may also be practiced without departing from the scope of the invention. Other modifications are therefore possible. For example, it may also be possible for software to be loaded onto a computer or an application on a dedicated website or online sales portal. Additionally, it may be possible to integrate the system of the present invention with lead generation/marketing automation programs to automatically assign persona based on behaviour

1. A computer system for customer relationship management operable upon a computer processor, comprising:
(a) a computer configured to operate, by one or more computer processors, at least one of the following tools;
(i) a persona data collection tool configured to generate persona data from persona input;
(ii) a prospect data collection tool configured to generate prospect data from prospect input;
(iii) a rules processor; and
(iv) one or more logic models;
wherein the rules processor and the one or more logic models utilize the persona data and prospect data to determine a situation match; and
wherein the situation match is conveyed to one or more users.

2. A system of claim 1, wherein the situation match is configured to generate intelligent advice and said intelligent advice is conveyed to the one or more users.

3. A system of claim 1, wherein the intelligent advice is conveyed to the one or more users as one or more of the following: text, visual display, a conversation playbook generated by a conversation playbook module, or resources determined by a resources builder module.

4. A system of claim 1, wherein the one or more users may access the persona data collection tool and select one or more personas and generate persona data therefrom.

5. A system of claim 1, wherein at least one of the following may be generated from survey data: persona input, or prospect input.

6. A system of claim 1, wherein the situation match may be applied as at least one of the following: a sales conversation guide; and a sales representative training tool.

7. A computer implemented method for customer relationship management comprising the steps of:
(a) providing at least one of the following:
(i) input persona data to a persona data collection tool that facilitates storage of said input persona data upon a storage means; and
(ii) input prospect data to a prospect data collection tool that facilitates storage of said input prospect data upon a storage means;
(b) accessing, or facilitating the accessing, by one or more computer processors, the prospect data collection tool and generating prospect data relevant to at least one prospect;
(c) comparing prospect data to at least one scenario matrixes in accordance with at least one logic models to identify a situation match based upon the comparison and identify one or more personas; and
(d) providing information regarding the one or personas to a user.

8. The computer implemented method of claim 7, comprising the further steps of:
(a) utilizing the situation match to generate at least one of the following: advice, one or more resources, and content, as prospect information;
(b) providing the prospect information to the user; and
(c) utilizing the prospect information as a basis for conversing with the prospect.

9. The computer implemented method of claim 8, comprising the further steps of:
(a) utilizing the situation match to generate intelligent advice as the prospect information;
(b) providing the intelligent advice to the user as a conversation playbook; and
(c) utilizing the conversation playbook to converse with the prospect.

10. The computer implemented method of claim 7, comprising the further step of: linking one or more personas to the prospect information.

11. The computer implemented method of claim 7, comprising the further step of: generating the input persona data from at least one survey.

12. The computer implemented method of claim 7, comprising the further step of: generating the input persona data from at least one survey.

13. A computer program product storing instructions and data to configure a computer system for performing customer relationship management, the computer program product comprising:
(a) said instructions and data for configuring one or more computer processors to apply, or facilitate the application of, at least one logic model utilizing at least one of the following:
(i) persona data accessed from a persona data collection tool that facilitates storage of said persona data upon a storage means;
(ii) prospect data accessed from a prospect data collection tool that facilitates storage of said input prospect data upon a storage means; and
(iii) at least one scenario matrix;
to generate a situation match for one or more users.

14. The product of claim 13, wherein the instructions and data configure the computer system for generating the situation match through the comparison of the prospect data to at least one scenario matrix in accordance with at least one rule of the at least one logic model.

15. The product of claim 14, wherein the instructions and data configure the computer system for identifying one or more personas by the generation of the situation match.

16. The product of claim 13, wherein the instructions and data configure the computer system for displaying the situation match as a conversation playbook to a user.

17. The product of claim 13, wherein the instructions and data configure the computer system for utilizing a solution logic model matrix to generate the situation match.

18. The product of claim 17, wherein the instructions and data configure the computer system for assessing one or more solutions accessed by the solution logic model matrix and scoring the one or more solutions against one or more factors.

19. The product of claim 13, wherein the instructions and data configure the computer system for providing a conversation guide or training tool based upon a persona relevant to the situation match.
